(19) United States
(12) Patent Application Publication
(10) Pub. No.: US 2026/0044159 A1
(43) Pub. Date: Feb. 12, 2026

(54) HIGH-INTEGRITY TRIPLEX AVIONICS

(71) Applicant: SAFRAN ELECTRONICS & DEFENSE, PARIS (FR)

(72) Inventors: Julien FARJON, MOISSY-CRAMAYEL (FR); Nicolas CADALEN, MOISSY-CRAMAYEL (FR)

(21) Appl. No.: 19/099,186

(22) PCT Filed: Jul. 31, 2023
(86) PCT No.: PCT/EP2023/071125

§ 371 Date: Jan. 28, 2025

(30) Foreign Application Priority Data
Aug. 4, 2022 (FR) FR2208104

(51) Int. Cl. G05D 1/87; G05D 109/20

(52) U.S. Cl. CPC G05D 1/87; G05D 2109/20

(57) ABSTRACT

A computer including a housing in which at least three processing pathways are integrated, each of which processing pathways includes: a first module arranged to acquire measurements produced by at least one sensor, to estimate navigation parameters and to check the validity of the navigation parameters by comparing them with those estimated by the other first modules; a second module arranged to generate commands on the basis of an aircraft trajectory setpoint and valid navigation parameters; a third module arranged to check the validity of the commands by comparing them with those estimated by the other second modules.

The invention relates to the field of avionics on board an aircraft (in a drone, for example).

### PRIORT ART OF THE INVENTION

A recently-adopted European regulation defines three categories for civilian drones: open category, specific category and certified category.

The open category relates to low-risk operations for aviation safety, the specific category relates to moderate-risk operations, and the certified category relates to high-risk operations.

Each category lists acceptable types of flight and operations according to the characteristics of the drones and, in particular, their weight and the control systems which equip them.

The invention is particularly advantageous for civil drones of the specific and certified categories-but it may be applied more generally to any type of drone, civil or military, and even to any type of aircraft.

Currently, the majority of civilian professional drones have a weight of less than 25 kg and can operate only in very sparsely-populated areas, within sight and under special conditions. Drones are used to, for example, monitor high-voltage lines.

There is no flight control avionics having both a high level of safety, and a weight, volume and cost compatible with such drones, that would make it possible to extend the field of action and the functions implemented by these drones, that would open up new market opportunities.

The solutions available to dronists are avionics whose level of safety is neither demonstrated nor even claimed. These avionics have safety levels which are in fact several orders of magnitude lower than what is needed to operate beyond visual range and over areas with higher population density.

To meet the safety requirements imposed, we have therefore decided to work on a reference system similar to that of certified aircraft organised in the ATA (i.e., the Air Transport Association), to implement the functions necessary for flight safety.

Implementing these functions makes it possible to benefit from the proofs of certification associated with standards such as ETSO (i.e., the European Technical Standard Order, ETSO C145, for example, Airborne navigation sensors using the GPS, etc.). In such an architecture, the different functions, carried by different items of equipment, communicate with one another using digital buses. The avionics available on the market mainly respond to this type of architecture, that is common today in aeronautics.

Nevertheless, these ATA architectures are clearly incompatible with the targeted drones, due to their weight, volume and cost.

Thus, proposals have been made to use the existing solutions developed for aircraft designed to comply with the EASA CS-23 certification specification, that is applicable to aircraft in any of the following categories: ‘normal’, ‘utility’, ‘aerobatic’ or ‘commuter’. The safety requirements for this type of aircraft are less important than those achieved by the ATA architectures, and are relatively close to the requirements for drones.

However, once again, these existing avionics solutions are not applicable to the drones in question, due to their weight, volume and cost.

It can thus be understood that existing avionics architectures, making it possible to obtain acceptable safety levels, are not compatible with the design requirements of drones, which are governed by the so-called “SWAP-C” requirements (i.e., the Size, Weight, Power and Cost requirements). These existing avionics cannot be embedded in drones, and there is currently no avionics that has an acceptable level of safety in a volume and cost compatible with a drone with a weight of less than 200 kg. Documents US20140027564A1 and US2018/001994A1 disclose the computers which have several processing pathways.

The processing pathways of each computer differ from one another, each given processing pathway having its own specificity that differs from the specificities of the other processing pathways.

### AIM OF THE INVENTION

The aim of the invention is to provide avionics having a high level of safety, and reduced weight, volume and cost.

### SUMMARY OF THE INVENTION

In view of achieving this aim, a computer is proposed, arranged to be on board an aircraft that comprises at least one flight control actuator, the computer comprising a housing in which at least three processing pathways are integrated, which are physically separated, each processing pathway comprising:
a first module arranged to acquire measurements produced by at least one sensor associated with said processing pathway, to estimate navigation parameters on the basis of these measurements, and to check a first validity of the navigation parameters by comparing them with those estimated by the first modules of the other processing pathways;
a second module arranged to generate commands on the basis of an aircraft trajectory setpoint and navigation parameters estimated by the first module of said processing pathway and whose first validity has been verified;
a third module arranged to check a second validity of the commands by comparing them with those generated by the second modules of the other processing pathways;
the computer being arranged to transmit the commands, the second validity of which has been verified, to control the flight control actuator(s).

Integrating three physically separate processing pathways into a single computer, each associated with at least one separate sensor, and each comprising modules which calculate and verify navigation parameters and controls, makes it possible to obtain avionics with a high level of safety and reduced weight, volume and cost.

In addition, a computer is proposed, such as described above, in which, for each processing pathway, the sensor(s) associated with said processing pathway comprise(s) at least one external sensor located outside the computer, and/or at least one internal sensor integrated into said processing pathway.

In addition, a computer is proposed, such as described above, in which, for each processing pathway, the external sensor(s) associated with said processing pathway comprise(s) at least one pressure sensor and one magnetometer, and wherein the navigation parameters comprise an air speed, an altitude and a magnetic heading.

In addition, a computer is proposed, such as described above, in which, for each processing pathway, the internal sensor(s) associated with said processing pathway comprise sensors integrated into a satellite positioning system and into an inertial measuring unit integrated into said processing pathway, and wherein the navigation parameters comprise a position and an attitude.

In addition, a computer is proposed, such as described above, in which, for each processing pathway, the computer is arranged such that, if the first validity of a navigation parameter estimated by the first module of said processing pathway is not verified, it is no longer possible to use a sensor that is associated with said processing pathway and that has been used to estimate said navigation parameter.

In addition, a computer is proposed, such as described above, in which, for each processing pathway, the computer is arranged such that, if the first validity of a navigation parameter estimated by the first module of said processing pathway is not verified, said processing pathway is deactivated.

In addition, a computer is proposed, such as described above, in which, at a time T, the processing pathways comprise a current master pathway, the computer being arranged to:
if the second validity of the commands generated by the second module of the current master pathway is verified, use said commands to control the flight control actuator(s);
otherwise, deactivate the current master pathway and designate a new master pathway.

In addition, a computer is proposed, such as described above, in which, for each processing pathway, the verification of the second validity performed by the third module comprises a bit-by-bit comparison and a majority vote.

In addition, an avionics system is proposed, comprising:
at least three items of measuring equipment each integrating at least one external sensor;
a computer as described above, each processing pathway of the computer being connected to one of the items of measuring equipment;
at least one flight control actuator;
separate interface equipment, associated with each flight control actuator,
each item of interface equipment (6) being connected to the computer (3) and to said flight control actuator (5) and being arranged to acquire a command emitted by the computer (3), to transmit said command to said flight control actuator to control it, and to relay, to the computer, uplink signals representative of an operation of said flight control actuator.

In addition, in avionics system is proposed, such as described above, said interface equipment being arranged to be connected to a power supply source integrated into the aircraft, and to provide a power supply voltage to the flight control actuator to power it.

In addition, an avionics system is proposed, such as described above, in which the uplink signals comprise monitoring signals representative of a state of the flight control actuator.

In addition, an avionics system is proposed, such as described above, in which the uplink signals comprise return signals which are used by the second modules of the processing pathways of the computer to produce the commands.

In addition, an avionics system is proposed, such as described above, in which the return signals are representative of a position of a rotor of an electric motor of the flight control actuator and/or of a position of a member actuated by said electric motor.

In addition, an aircraft comprising an avionics system is proposed, such as described above.

In addition, an aircraft is proposed, such as described above, the aircraft being a drone.

The invention will be best understood in the light of the description below of a particular, non-limiting embodiment of the invention.

### BRIEF DESCRIPTION OF THE DRAWINGS

Reference will be made to the accompanying drawings, among which:

FIG. 1 shows an avionics system of a drone, that comprises a computer, measurement equipment, interface equipment, and flight control actuators;

FIG. 2 is a view similar to FIG. 1, the computer being shown in more detail;

FIG. 3 shows interface equipment.

### DETAILED DESCRIPTION OF THE INVENTION

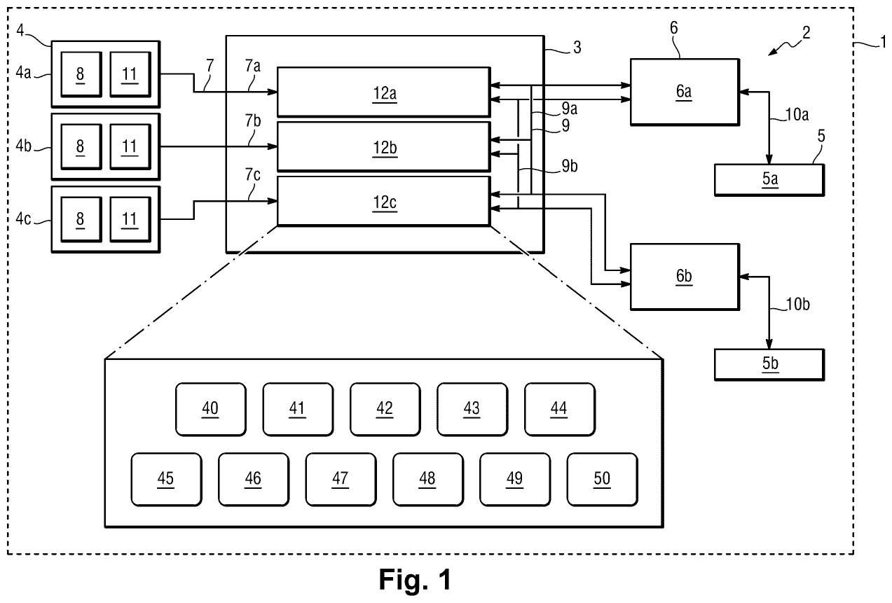

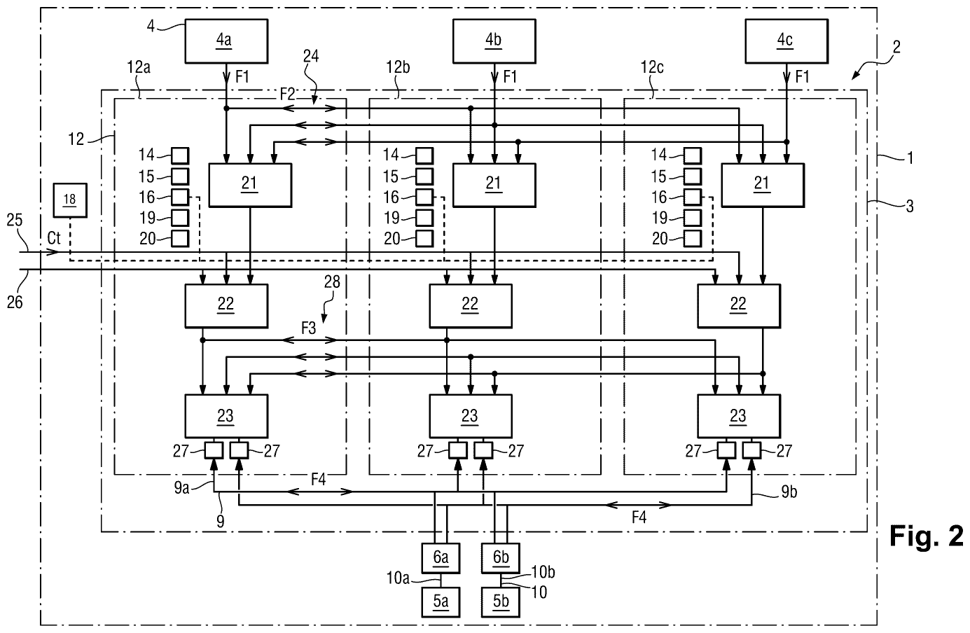

With reference to FIGS. 1 and 2, a drone 1 integrates an avionics system 2 that comprises a computer 3, at least one item of measurement equipment 4 (in this case, three items of measurement equipment 4a, 4b, 4c are shown), at least one flight control actuator 5 (in this case, two flight control actuators 5a, 5b are shown), and one item of interface equipment 6 for each flight control actuator 5 (in this case, therefore two items of interface equipment 6a, 6b).

Of course, the architecture represented is not at all limiting and, in particular, the number of measuring equipment 4, the number of flight control actuators 5 and the number of interface equipment 6, which are actually embedded in the drone 1, may be different. In particular, the number of flight control actuators 5 is, in fact, probably greater and, for example, equal to six or eight.

The three items of measuring equipment 4 are identical, but independent and physically separate. The three items of measuring equipment 4 measure the same quantities.

The computer 3 is connected to each item of measuring equipment 4 by digital links 7: 7a, 7b, 7c.

Each item of measuring equipment 4 integrates at least one external sensor 8, as well as one processing module 11. The term “external sensor” is used to mean that the sensor(s) are not integrated into the computer 3. Each item of measuring equipment 4 integrates at least one pressure sensor (in this case, a barometer and a Pitot probe) and one magnetometer.

The processing module 11 of each item of measuring equipment 4 digitises the measurements produced by the external sensors 8 of said item of measuring equipment 4, and transmits these digitised “raw” measurements to the computer 3 via the corresponding digital link 7.

The measurements thus travel, from the measuring equipment 4 to the computer 3, according to the flows F1, which are unidirectional and independent flows.

The flight control actuators 5 (referred to from now on as “actuators” to simplify the description) comprise, for example, one or more control surface actuators of the drone 1 and/or one or more motor actuators of the drone 1. The actuators 5 are COTS actuators (i.e., Commercial Off-The-Shelf, meaning that they are available actuators which do not have any particular characteristics to be integrated into the avionics system 2 described here).

The computer 3 is connected to the actuator 5a via the interface equipment 6a and to the actuator 5b via the interface equipment 6b.

The computer 3 is connected to the interface equipment 6a and to the interface equipment 6b by two separate CAN buses 9 (CAN stands for Controller Area Network): a CAN bus 9a and a CAN bus 9b.

Each item of interface equipment 6 is connected to an actuator 5 by a CAN bus 10: the interface equipment 6a is connected to the actuator 5a by a CAN bus 10a, and the interface equipment 6b is connected to the actuator 5b by a CAN bus 10b.

The computer 3 comprises a housing in which at least three physically separate processing pathways 12 are integrated. In this example, the computer 3 comprises three processing pathways 12a, 12b and 12c.

Each processing pathway 12 is connected to an item of measuring equipment 4 (distinct): the processing pathway 12a is connected to the item of measuring equipment 4a by the link 7a, the processing pathway 12b is connected to the item of measuring equipment 4b by the link 7b and the processing pathway 12c is connected to the item of measuring equipment 4c by the link 7c.

Each processing pathway 12 comprises at least one internal sensor. In this case, each processing pathway 12 comprises several internal sensors, comprising sensors integrated into a satellite positioning system 14 (or GNSS, i.e., Global Navigation Satellite System) and into an inertial measuring unit 15 (or IMU, i.e., Inertial Measurement Unit), which are themselves integrated into said processing pathway 12.

Each processing pathway 12 further comprises power supply components 16 which power said processing pathway 12 on the basis of two power sources 18 of the drone 1 which the computer 3 is connected to. Generally, both power sources 18 are batteries.

Each processing pathway 12 further comprises one or more processing components 19, and, for example, any general-purpose or specialised processor or microprocessor (for example, a DSP, i.e., a Digital Signal Processor, or a GPU, i.e., a Graphics Processing Unit), a micro-controller, or a programmable logic circuit, such as an FPGA (i.e., Field Programmable Gate Arrays) or an ASIC (i.e., an Application Specific Integrated Circuit).

Each processing pathway 12 also comprises one or more memories 20. At least one of these memories 20 forms a computer-readable storage medium, on which at least one computer program is stored, comprising instructions which allow the processing pathway 12 to perform the functions described here. One of these memories 20 may be integrated into one of the processing components 19.

Each processing pathway 12 further comprises a first module 21, a second module 22 and a third module 23.

In this case, the modules 21, 22, 23 are functional modules and are implemented in the processing component(s) 19 which have just been described. The modules 21, 22, 23 may be purely software modules, purely hardware modules, or alternatively, partially software and partially hardware modules.

A more detailed description of the operation of the computer 3 is described below.

As mentioned above, each processing pathway 12 is associated with at least one external sensor 8 (in this case, three) and/or (in this case, and) with at least one internal sensor (which are integrated, in this case, in a GNSS 14 and in an IMU 15).

In each processing pathway 12, the first module 21 acquires the measurements produced by the sensors associated with said processing pathway 12, i.e., by the external sensors 8 of the measuring equipment 4 which said processing pathway 12 is connected to, and by the internal sensors 14, 15 integrated into said processing pathway 12.

The first module 21 of said processing pathway 12 then estimates the navigation parameters on the basis of these measurements.

In this case, the navigation parameters comprise an air speed, an altitude and a magnetic heading (of the drone 1), obtained on the basis of the measurements produced by the external sensors 8, and a position and an attitude (of the drone 1), obtained on the basis of the measurements produced by the satellite positioning system 14 and by the inertial measuring unit 15.

The first modules 21 of the three processing pathways 12 then exchange the navigation parameters which they have each estimated on the basis of the sensors associated with their processing pathway 12.

The navigation parameters travel between the first modules 21 according to flows F2, on an internal inter-pathway bus 24.

Each first module 21 also transmits, via the internal bus 24, monitoring signals from the internal sensors 14, 15 and the external sensors 8 associated with the processing pathway 12 which said first module 21 belongs to. For each sensor, the monitoring signals comprise information about the state of said sensor (e.g., normal state, failure, sensor connection problem, etc.).

The first module 21 of each processing pathway 12 then verifies a first validity of the navigation parameters that it has estimated by comparing them with those estimated by the first modules 21 of the other processing pathways 12.

To do so, the first module 21 of each processing pathway 12, for each navigation parameter, compares the value of said navigation parameter that it has estimated with an average of the values of the same applied navigation parameter estimated by the first modules 21 of the other processing pathways 12.

A first vote is therefore performed by each first module 21 based on the navigation parameters.

If the value of the navigation parameter that said first module 21 has estimated is included in an interval [M−α; M+α], where M is the average and a is a margin of tolerance, the first module 21 deems the first validity of said navigation parameter as not verified, i.e., the navigation parameter that it has estimated is valid.

If the value of said navigation parameter is not included in this interval, the first module 21 deems the first validity of said navigation parameter as not verified, i.e., the navigation parameter that it has estimated is not valid.

In terms of each processing pathway 12, if the first validity of a navigation parameter estimated by the first module 21 of said processing pathway 12 is not verified, the computer 3 no longer uses the sensor (external or internal) that is associated with said processing pathway 12 and that has been used to estimate said navigation parameter.

Alternatively, in terms each processing pathway 12, if the first validity of a navigation parameter estimated by the first module 21 of said processing pathway 12 is not verified, the computer 3 deactivates said processing pathway 12. Thus, the computer 3 switches from a triplex configuration (with three pathways) to a dual lane configuration (with two pathways). The external 8 sensors and internal sensors 14, 15 associated with said processing pathway 12 are no longer used.

Each processing pathway 12 receives, via a digital link 25, a trajectory setpoint Ct from the drone 1.

The trajectory setpoint Ct of the drone 1 is, for example, pre-recorded in the computer 3 or in another item of equipment of the drone 1, or is calculated in real time by the computer 3 or by another item of equipment of the drone 1, or is sent by a ground station, by another aircraft, etc.

Each processing pathway 12 also receives, via a digital link 26, flight control monitoring signals, which are transmitted to the computer 3 by equipment that monitors the flight controls, or by functions internal to the computer 3.

The second module 22 of each processing pathway 12 then generates commands on the basis of the trajectory setpoint Ct of the drone 1 and of the navigation parameters estimated by the first module 21 of said processing pathway 12, the first validity of which has been verified.

In terms of each flight control, the controls are generated only if the flight control monitoring signals indicate that it is operating correctly.

Each second module 22 then transmits the commands which it has generated to all of the third modules 23.

The commands thus travel from the second modules 22 to the third modules 23, according to flows F3. This data circulates on an internal bus 28 (in this case, an Ethernet bus), inter-pathway.

In each processing pathway 12, the third module 23 of said processing pathway 12 verifies a second validity of the commands that the second module 22 of said processing pathway 12 has generated, by comparing them with the commands generated by the second modules 22 of the other processing pathways 12.

For each processing pathway 12, the comparison performed by the third module 23 is a bit-by-bit comparison between the data in order to detect, via a majority vote (2 out of 3), a faulty processing pathway 12. Bit-by-bit voting makes it possible to avoid using a logic of thresholds or averages, and makes voting simpler and more robust. However, this method requires a synchronisation of the processes between the different processing pathways 12, in order to ensure that the calculations are performed simultaneously on the basis of the same data.

Via the bus 28 and along each of the pathways 12, the third modules 23 send information on the current state of the validity of the calculation of commands.

Each third module 23 is connected to two CAN transceivers 27, one connected to the CAN bus 9a and the other connected to the CAN bus 9b. The CAN transceivers 27 convert the signals produced by the third modules 23 into signals compatible with a CAN bus.

Each processing pathway 12a, 12b, 12c is connected to the interface equipment 6a by the CAN bus 9a and by the CAN bus 9b, and to the interface equipment 6b by the can bus 9a and the can bus 9b. Using both CAN buses 9a and 9b makes it possible to introduce redundancy into the link.

At time T, the processing pathways 12 comprise a current master pathway. For example, when the computer 3 starts up, the master pathway is the processing pathway 12a.

If the second validity of the commands generated by the second module 22 of the current master pathway 12a is verified, the commands generated by said second module 22 of the processing pathway 12a are transmitted on the CAN buses 9a and 9b to control the actuators 5a, 5b.

On the other hand, if the second validity of the commands generated by the second module 22 of the current master pathway 12a is not verified, i.e., if at least one command intended for at least one actuator is not valid, the computer 3 deactivates the current master pathway and designates a new master pathway. It is possible, for example, to arrange for the new master pathway to be assigned to pathway 12b, whenever the current master pathway is pathway 12a and the commands produced by this pathway are invalid. Likewise, after pathway 12b, pathway 12c becomes the new master pathway.

As mentioned above, the computer 3 is connected to each actuator 5 via separate interface equipment 6.

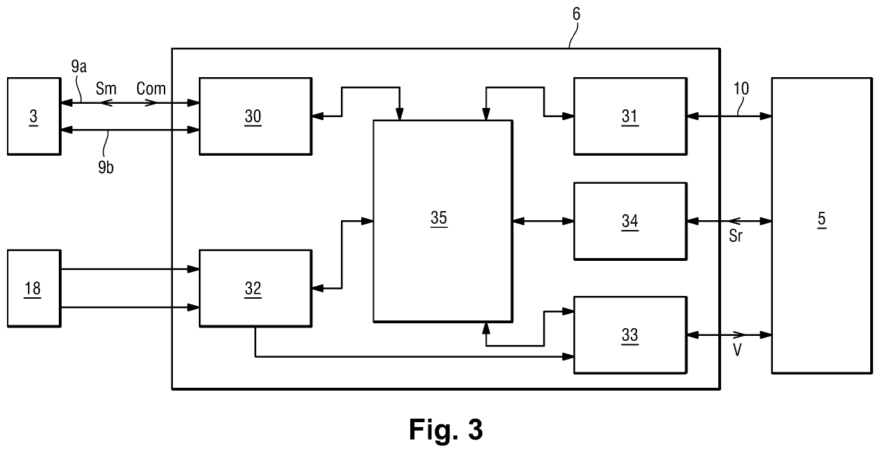

With reference to FIG. 3, each item of interface equipment 6 comprises a computer interface module 30, an actuator interface module 31, a power supply management module 32, a power supply and supervision module 33, a return module 34, and a processing and diagnostics module 35.

The power supply management module 32 is connected to the power supply source 18. The power supply management module 32 receives a power supply generated by the power supply source 18 and produces at least one power supply voltage for powering the interface equipment 6 and the actuator 5 which the interface equipment 6 is connected to. The power supply management module 32 produces monitoring signals representative of a state of the power supply source 18, and transmits them to the processing and diagnostics module 35.

The power supply and the supervision module 33 supplies the power supply voltage V to the actuator 5 (more precisely, to the electric motor of the actuator 5). The power supply and supervision module 33 monitors the consumption of the actuator 5. The power supply and supervision module 33 attempts, in particular, to detect an anomaly in the current consumed (zero, too high, etc.). The power supply and supervision module 33 produces monitoring signals representative of an electrical consumption of the actuator 5, and transmits them to the processing and diagnostics module 35.

The computer interface module 30 is connected to the computer 3 via the CAN buses 9a and 9b, and receives the commands Cm transmitted by the current master pathway (in this case, the pathway 12a).

The processing and diagnostics module 35 acquires the commands Com and, if necessary, performs any processing required by means of the commands Com. In particular, if necessary, the processing and diagnostics module 35 converts the commands Com into a format compatible with the actuator 5. The processing and diagnostics module 35 also verifies that the data travelling via both CAN buses 9a and 9b are indeed coherent.

The processing and diagnostics module 35 then transmits the commands Com to the actuator 5 to control it, via the actuator interface module 31 and the bus 10.

The processing and diagnostics module 35 also acquires, via the actuator interface module 31 and the bus 10, monitoring signals, produced by the actuator 5, and representative of a state of the actuator 5.

The feedback module 34 acquires feedback signals Sr. In this case, the return signals Sr are analogue signals produced by the actuator 5 (i.e., by one or more sensors integrated in or connected to the actuator 5).

The actuator 5 comprises an electric motor and a member that is actuated by the electric motor.

The return signals Sr are representative of a position of the rotor of the electric motor and/or a position of the member actuated by the electric motor of the actuator 5. The position feedback is independent of the command.

The feedback module 34 transmits the feedback signals Sr to the processing and diagnostics module 35.

The processing and diagnostics module 35 performs processing and diagnoses relating to the operation of the actuator 5 and the power supply source 18, by using the different monitoring signals produced by the different modules of the interface equipment 6.

The processing and diagnostics module 35 relays the uplink signals to the computer Sm.

The commands Com and the uplink signals Sm travel according to the flows F4 on the CAN buses 9a and 9b.

The uplink signals Sm comprise monitoring signals representative of a state of the flight control actuator 5. The uplink signals Sm also comprise the return signals Sr.

The monitoring signals are used by the computer 3 to deactivate the actuator 5, if the latter is faulty. The computer 3 takes this fault into account in the actuator control laws. Specifically, the control laws may be adapted to the loss of a portion of the actuators (control allocation).

The return signals are used by the second modules 22 of the processing pathways 12 of the computer 3 to implement the control laws and to produce the commands for controlling the actuators 5.

It should be noted that the return signals may be different. In the event that the actuator 5 is controlled by a servo-control on another magnitude (torque, current, etc.), the return signals are then representative of this other magnitude.

The computer 3 and the avionics system 2 described above are particularly advantageous.

The computer 3 implements the following functions: I/O management 40 (input/output management), location 41, navigation 42, guidance 43, control 44, calculation of aerodynamic magnitudes 45, calculation of attitudes and heading 46, GNSS sensors 47, inertial sensors 48, state machine 49 (for control laws), monitoring and voting 50.

The computer 3 and the avionics system 2 make it possible to obtain avionics with a high level of integrity and safety, in a weight, volume and cost adapted to civilian professional drones. The avionics system 2 typically weighs less than 2 kg.

The integration, in a single housing, of the three pathways comprising their position and attitude sensors, calculation means, power supply components, and input/output management, makes it possible to limit the weight of wiring between pathways that is traditionally found on triplex architectures with three separate computers.

The implementation of distributed triplex voting logics, by means of the navigation parameters and by means of the commands, makes it possible to ensure that the commands provided are valid.

The use of a separate item of measuring equipment 4 associated with each processing pathway 12, integrating the static pressure, total pressure and magnetometer sensors, and communicating with the associated processing pathway 12 via a digital link 7, makes it possible to dispense with the pneumatic connections generally used, thereby making it easier to integrate the system 2 into the drone 1 and limiting its weight. In order to limit costs, each item of measuring equipment 4 only acquires measurements, digitises them and communicates them via the digital link 7. The calculations of the useful magnitudes (air speed, atmospheric pressure) are performed in each pathway 12 of the computer 3, in order to share the critical calculation functions. In addition, by limiting the length of the tyres, by placing the electronics as close as possible, the various equipment of system 2 is less sensitive to the formation of frost and/or ice.

The computer 3 implements a limited number of digital interfaces, which makes it possible to reduce the weight of the connectors.

The use of interface equipment 6, communicating by digital link with the computer 3, makes it possible to manage the specific interfaces of the drone 1 that the avionics is integrated into. This interface equipment 6 has the minimum communication and acquisition functions.

Each item of interface equipment 6 performs the monitoring functions of the actuators 5, which makes it possible to achieve the safety levels required on the flight control functional chain, while using COTS actuators (which do not necessarily integrate monitoring devices themselves).

The monitoring of each actuator 5 by the associated interface equipment 6 makes it possible, in particular, to detect abnormal operation of the actuator 5 and therefore to deactivate the latter rapidly, for example, by cutting off its power supply. This prevents the abnormal operation of the actuator 5 from degrading the operation of the drone 1 in a significant or even a dangerous way.

The data relayed by the interface equipment 6 makes it possible to implement health monitoring functions (or predictive maintenance) by means the actuators 5. Similarly, the comparison of the measurements performed by the first modules 21 of the computer 3 makes it possible to implement Health Monitoring functions by means of the external sensors 8 of the measuring equipment and by means of the internal sensors.

Naturally, the invention is not limited to the embodiment described, but covers any variation falling within the scope of the invention as defined by the claims.

The invention does not necessarily need to be implemented in a civilian drone, but may be applied to any type of drone.

The invention may also be implemented in an aircraft other than a drone, and, for example, in an aircraft certified according to the EASA CS-23 certification specification.

The computer may comprise a number of pathways other than three.

The external sensors may be different from those described above, and are not necessarily grouped in measuring equipment. It may be individual sensors. The internal sensors may likewise be different.

In the embodiment described, the buses used between the computer and the interface equipment, and between the interface equipment and the actuators, are CAN buses; it is of course possible to use different buses, and, for example, RS buses (e.g., RS485) or buses using the PWM technique (i.e., the Pulse Width Modulation technique).

1. A computer arranged to be on board an aircraft that integrates at least one flight control actuator, the computer comprising a housing in which at least three processing pathways are integrated, which are physically separated, characterised in that each processing pathway comprises:
a first module arranged to acquire measurements produced by at least one sensor associated with said processing pathway, to estimate navigation parameters on the basis of these measurements, and to check a first validity of the navigation parameters by comparing them with those estimated by the first modules of the other processing pathways;
a second module arranged to generate commands on the basis of an aircraft trajectory setpoint and navigation parameters estimated by the first module of said processing pathway and whose first validity has been verified;
a third module arranged to check a second validity of the commands by comparing them with those generated by the second modules of the other processing pathways;
the computer being arranged to transmit the commands, the second validity of which has been verified, to control the flight control actuator(s)
the computer being arranged such that, at a time T, the processing pathways comprise a current master pathway, the computer being arranged so that:
if the second validity of the commands generated by the second module of the current master pathway is verified, use said commands to control the flight control actuator(s)
otherwise, deactivate the current master pathway and designate a new master pathway.

2. The computer according to claim 1, wherein, for each processing pathway, the sensor(s) associated with said processing pathway comprise(s) at least one external sensor located outside the computer, and/or at least one internal sensor integrated into said processing pathway.

3. The computer according to claim 2, wherein, for each processing pathway, the external sensor(s) associated with said processing pathway comprise(s) at least one pressure sensor and one magnetometer, and wherein the navigation parameters comprise an air speed, an altitude and a magnetic heading.

4. The computer according to Claim 2, wherein, for each processing pathway, the internal sensor(s) associated with said processing pathway comprise(s) sensors integrated into a satellite positioning system and into an inertial measuring unit integrated into said processing pathway, and wherein the navigation parameters comprise a position and an attitude.

5. The computer according to claim 1, wherein, for each processing pathway, the computer is arranged, such that if the first validity of a navigation parameter estimated by the first module of said processing pathway is not verified, it is no longer possible to use a sensor that is associated with said processing pathway and that has been used to estimate said navigation parameter.

6. The computer according to Claim 2, wherein, for each processing pathway, the computer is arranged, such that if the first validity of a navigation parameter estimated by the first module of said processing pathway is not verified, said processing pathway is deactivated.

7. The computer according to Claim 1, wherein, for each processing pathway, the verification of the second validity performed by the third module comprises a bit-by-bit comparison and a majority vote.

8. An avionics system comprising:
at least three items of measurement equipment each including at least one external sensor;
a computer according to Claim 1, each processing pathway of the computer being connected to one of the items of measurement equipment;
at least one flight control actuator;
distinct interface equipment associated with each flight control actuator,
each interface equipment being connected to the computer and to said flight control actuator and being arranged to acquire a command emitted by the computer, to transmit said command to said flight control actuator to control it, and to relay, to the computer, uplink signals representative of an operation of said flight control actuator.

9. The avionics system according to claim 8, said interface equipment being arranged to be connected to a power supply source integrated into the aircraft, and to provide a power supply voltage to the flight control actuator to power it.

10. The avionics system according to Claim 8, wherein the uplink signals comprise monitoring signals representative of a state of the flight control actuator.

11. The avionics system according to Claim 8, wherein the uplink signals comprise return signals which are used by the second modules of the processing pathways of the computer to produce the commands.

12. The avionics system according to claim 11, wherein the return signals are representative of a position of a rotor of an electric motor of the flight control actuator and/or of a position of a member actuated by said electric motor.

13. The aircraft comprising an avionics system according to Claim 8.

14. The aircraft according to claim 13, the aircraft being a drone.
